(19) United States
(12) Patent Application Publication
(10) Pub. No.: US 2003/0094833 A1
(43) Pub. Date: May 22, 2003

(54) Camping trailer with retractable awning

(75) Inventors: Scott P. Thompson, Longmont, CO (US); Garret Mauldin, Arvada, CO (US); Christopher M. White, Frederick, CO (US)

Correspondence Address: DORSEY & WHITNEY, LLP, INTELLECTUAL PROPERTY DEPARTMENT, 370 SEVENTEENTH STREET, SUITE 4700, DENVER, CO, 80202-5647, US

(73) Assignee: Carefree/Scott Fetzer Company, Broomfield, CO

(21) Appl. No.: 10/300,048

(22) Filed: Nov. 19, 2002

Related U.S. Application Data
(60) Provisional application No. 60/332,524, filed on Nov. 21, 2001.

(51) Int. Cl. B60P 3/355

(52) U.S. Cl. 296/163; 296/173

(57) ABSTRACT

A retractable awning combined with an expandable camping trailer includes telescoping support arms and rafter arms that support a roll bar and an awning sheet secured thereto. The support arms and rafter arms automatically extend when the trailer is expanded from a collapsed position and are further extendable into a deployed use position and locked in this position by appropriately manipulating the support and rafter arms and securing them in extended positions with lock mechanisms. The support and rafter arms are conditioned for retraction by releasing the lock mechanisms and positioning the awning adjacent to the side of the trailer such that when the trailer is collapsed by dropping the top of the trailer downwardly toward the bottom of the trailer, the support and rafter arms automatically collapse into nested relationships.

### CROSS REFERENCE TO RELATED APPLICATIONS

The present application claims priority to Provisional Application Serial No. 60/332,524, filed Nov. 21, 2001 and entitled AWNING SYSTEM FOR POP-UP TRAVEL TRAILERS, the disclosure of which is hereby incorporated by reference.

### BACKGROUND OF THE INVENTION

1. Field of the Invention

The present invention relates generally to retractable awnings and more particularly to a retractable awning designed for use with pop-up camping trailers.

2. Description of Relevant Art

Pop-up or collapsible trailers are popular with campers as they can be towed behind relatively small vehicles so that the users do not have to own a vehicle specifically designed for towing heavy loads but can enjoy a camping trailer experience. Pop-up trailers are very efficiently designed and when collapsed are relatively compact having a bottom wall mounted on a framework that is supported on a pair of wheels and having a trailer hitch for attachment to a tow vehicle. Surrounding the bottom wall is a lower peripheral wall which is connected to an upper peripheral wall by an expansible sidewall. The expansible sidewall can take numerous forms including a flexible fabric or canvas material or telescoping panels of a similar configuration to that of the upper and lower peripheral walls.

When expanding the trailer from a collapsed position, the upper peripheral wall is lifted and vertically separated from the lower peripheral wall in a conventional manner but remains attached through the expansible sidewall to the lower peripheral wall. Fold-out panels may be provided along sides of the trailer providing extra space in the trailer when it is expanded. When collapsed, however, all components of the trailer are compactly confined between the bottom wall and the upper and lower peripheral walls which are positioned immediately adjacent to each other.

Other forms of camping facilities have also become very popular such as recreational vehicles and the like and with such mobile camping facilities, many amenities have become desirable and in some instances expected. One such amenity is a retractable awning mounted on the side of the vehicle to provide its user with a shaded area along the side of the vehicle. Such retractable awning systems are fairly large and typically utilize a roll bar about which an awning sheet can be wrapped with the roll bar being supported by a pair of support arms and a pair of rafter arms which retain the awning in an extended and taut condition. In order that the awning can extend a substantial distance away from the side of the vehicle, it is necessary that the support and rafter arms be relatively long, usually approaching the height of the vehicle. For this reason, retractable awnings have not been available for use with pop-up trailers as pop-up trailers have a very low profile when collapsed.

Accordingly, while pop-up camping trailers are very efficiently designed and include a surprising amount of space once they have been expanded, they have traditionally not been capable of carrying a retractable awning due to the relatively large size of the awning in comparison to the small compact nature of the trailer when collapsed.

On the other hand, users of pop-up camping trailers could benefit from a retractable awning and it would therefore be desirable for retractable awnings to accommodate the relatively small compact size of a pop-up trailer so as to be carried thereby. It is to satisfy this need that the present invention has been developed.

### BRIEF SUMMARY OF THE INVENTION

A retractable awning specifically adapted for use with pop-up trailers includes an awning sheet secured along an inner edge to the trailer and along an outer edge to a roll bar about which the awning sheet can be wrapped. As is well known in the art, the roll bar could alternatively be secured to the inner edge and a lead bar to the outer edge. In the disclosed embodiment, the roll bar is supported at opposite ends by a pair of support arms having their lower or inner ends pivotally and removably connected to the pop-up trailer so that the support arms can pivot away from the side of the trailer when the awning is extended. A pair of rafter arms are also connected to the pop-up trailer and are adapted to operatively engage the roll bar so as to brace the awning and retain it in a taut condition.

The pop-up trailer has a lower peripheral wall and an upper wall with the upper peripheral wall being separable from the lower peripheral wall when expanding the trailer. The awing sheet is carried by the upper peripheral wall while the support arms are pivotally connected to the lower peripheral wall. The support arms are longitudinally extensible so that as the trailer is moved from a collapsed condition to an expanded condition, the support arms automatically elongate to accommodate the expanded height of the trailer. The rafter arms are also longitudinally extensible as the trailer is expanded so that once the support arms have been extended by the expansion of the pop-up trailer, the support arms can be pivoted away from the side of the trailer and the rafter arms moved into a bracing relationship with the support arms to hold the awning in a desired extended position.

In the extended position, both the support arms and rafter arms are locked at a predetermined length. To retract the awning prior to collapsing the pop-up trailer, the support and rafter arms are released to permit a shortening of their effective length thereby accommodating the movement of the pop-up trailer from its extended to collapsed condition.

Other aspects, features and details of the present invention can be more completely understood by reference to the following detailed description of the preferred embodiment, taken in conjunction with the drawings and from the appended claims.

### BRIEF DESCRIPTION OF THE DRAWINGS

FIG. 1 is an isometric view of a pop-up trailer having the awning of the present invention in a first extended position.

FIG. 2 is an isometric view of the pop-up trailer and awning of FIG. 1 in a collapsed and retracted position.

FIG. 3 is an isometric view similar to FIG. 1 with the awning in an alternative expanded position.

FIG. 4 is an enlarged fragmentary section taken along line 4-4 of FIG. 3.

FIG. 5 is an enlarged fragmentary section taken along line 5-5 of FIG. 2.

FIG. 6 is an enlarged fragmentary isometric similar to FIG. 1.

FIG. 7 is a fragmentary isometric showing the upper end of a support arm and rafter arm connected to the roll bar in a retracted condition of the trailer and the awning.

FIG. 8 is a fragmentary isometric similar to FIG. 7 with the trailer being expanded and the awning being initially extended from the fully retracted position of FIG. 7.

FIG. 9 is an enlarged fragmentary section taken along line 9-9 of FIG. 2.

FIG. 10 is an enlarged fragmentary section taken along line 10-10 of FIG. 2.

FIG. 11 is an enlarged fragmentary section taken along line 11-11 of FIG. 5.

FIG. 12 is an enlarged section taken along line 12-12 of FIG. 6.

FIG. 13 is an enlarged fragmentary section taken along line 13-13 of FIG. 12.

FIG. 14 is an enlarged section similar to FIG. 13 with the pivotal lock in a locking position.

FIG. 14A is an enlarged section taken along line 14A-14A of FIG. 14 showing stop buttons in a non-engaging relationship.

FIG. 14B is a section similar to FIG. 14A with the stop buttons in an engaging relationship.

FIG. 15 is a fragmentary longitudinal section taken through a rafter arm.

FIG. 16 is a view taken along line 16-16 of FIG. 15.

FIG. 17 is an enlarged section taken along line 17-17 of FIG. 16.

FIG. 18 is a fragmentary view similar to FIG. 16 with the component parts of the rafter arm in different relative positions.

FIG. 19 is an enlarged section taken along line 19-19 of FIG. 18.

FIG. 20 is a fragmentary longitudinal section taken along a support arm with the support arm in a retracted position.

FIG. 21 is an enlarged fragmentary section taken along line 21-21 of FIG. 6 showing a support arm in an extended position.

FIG. 22 is a fragmentary longitudinal section taken through a support arm illustrating a spring-lock pin in an operating position.

FIG. 23 is an exploded isometric of a rafter arm with parts removed for clarity.

FIG. 24 is an exploded isometric of a support arm.

FIG. 25 is an exploded fragmentary isometric showing the upper end of a support arm and rafter arm to show the interconnection therebetween.

FIG. 26 is an isometric view of the pivot arm of a spring-lock pin used in a support arm of the awning.

FIG. 27 is an isometric of the base component of a spring-lock pin as used in a support arm of the awning.

FIG. 28 is a fragmentary isometric of a portion of a support arm where a spring-lock pin mechanism is mounted.

### DETAILED DESCRIPTION OF THE PREFERRED EMBODIMENT

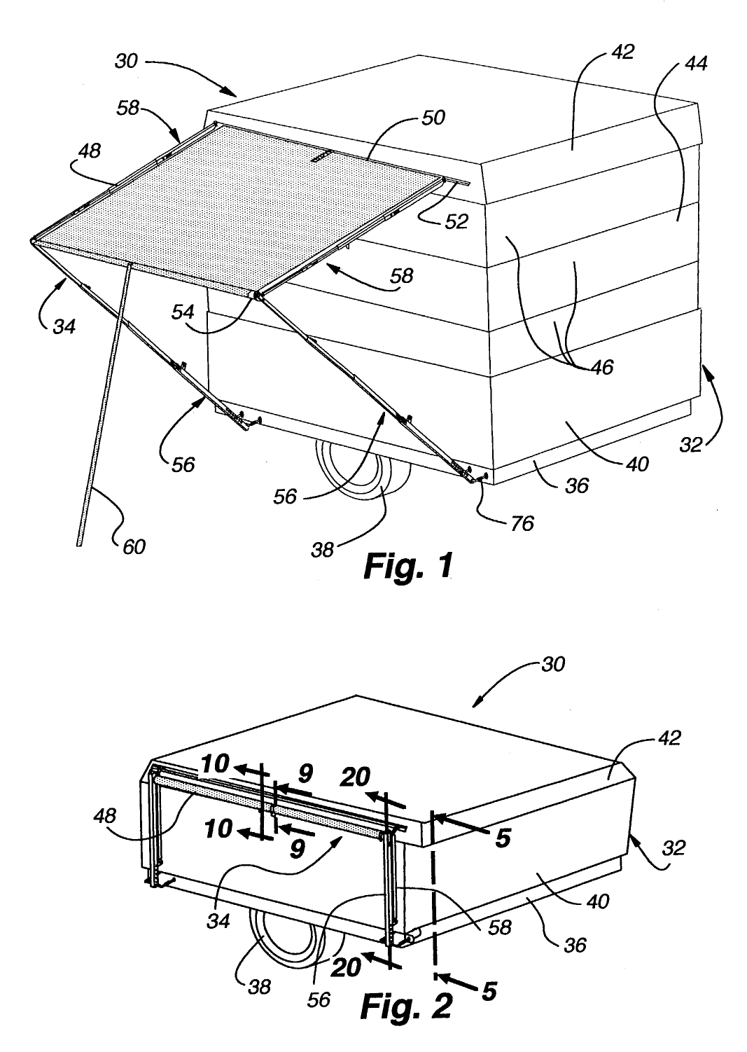

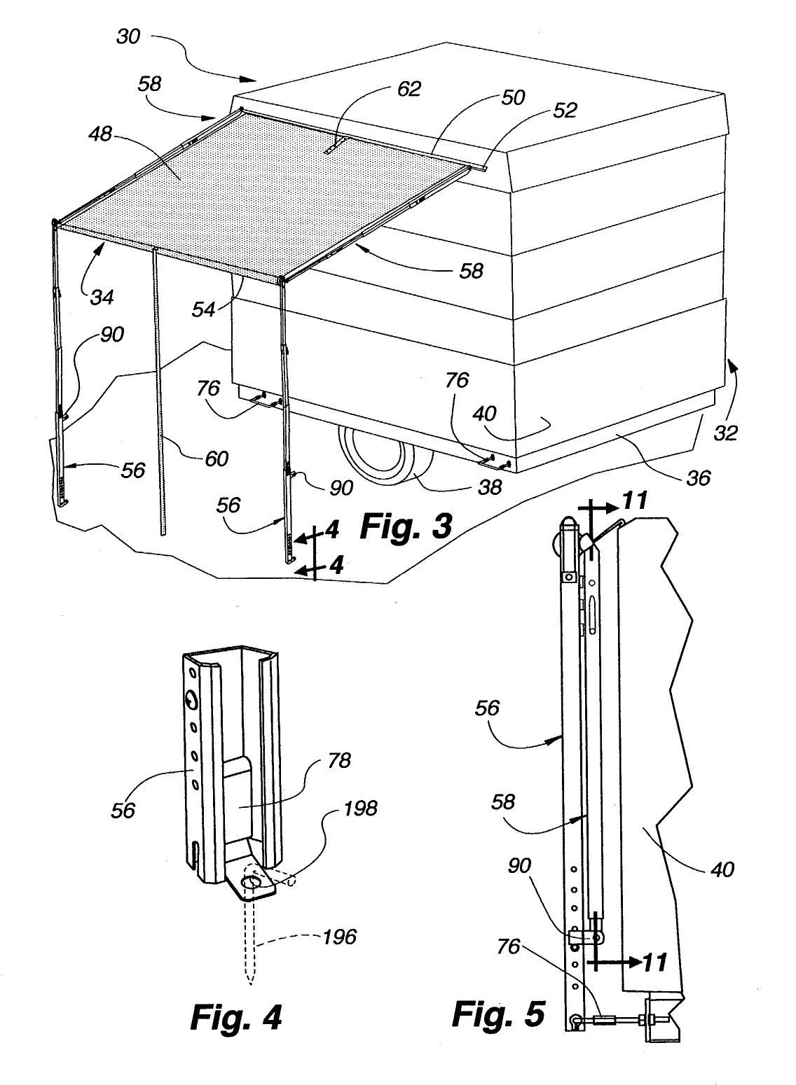

A camping trailer/retractable awning combination 30 in accordance with the present invention is seen best in FIGS. 1-3 with FIGS. 1 and 3 showing the trailer 32 in an expanded condition and FIG. 2 showing the trailer in a collapsed position. In FIG. 2, the awning 34 is fully retracted, while the awning is fully extended in FIGS. 1 and 3 in two optional forms of extension.

The camping trailer 32 is of a conventional type having a frame 36 on which a pair of supporting wheels 38 are mounted and a trailer hitch (not seen) at one end of the frame adapted for attachment to a tow vehicle. The frame is of quadrilateral configuration and supports a bottom wall (not seen), a lower peripheral upstanding wall 40 which is rigid in construction, and an upper peripheral wall 42, which is also of rigid construction. The upper peripheral wall is mounted for vertical movement between a collapsed position as seen in FIG. 2 in adjacent relationship with the lower peripheral wall and an expanded position shown in FIGS. 1 and 3 where it is vertically spaced from the lower peripheral wall. The lower peripheral wall and upper peripheral wall are interconnected by an expansible side wall 44 and while the expansible side wall could be a flexible fabric material such as canvas as is commonly found in such travel trailers used by campers, it is illustrated as having telescoping side wall panels 46. The movement of the trailer between collapsed and expanded positions is not described in detail herein as such systems are well known in the art. The systems include means for releasably retaining the camper trailer in either the collapsed or expanded position.

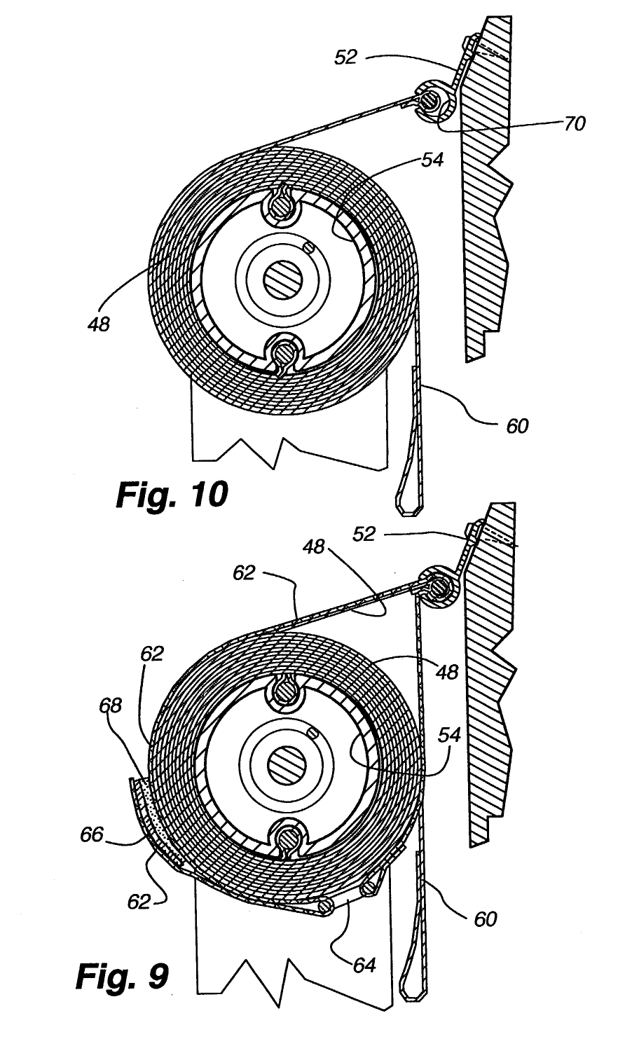

The retractable awning 34 includes an awning sheet 48 secured along an inner edge 50 to one side of the upper peripheral wall 42 with a mounting rail 52 and having its opposite edge secured to a roll bar 54. The roll bar is conventional in the trade and includes internal spring-biasing means (not seen) for biasing the roll bar in one predetermined rotational direction about a longitudinal axis which causes the awning sheet to be wrapped therearound as the roll bar is moved toward the side of the trailer 32. The roll bar is supported by a pair of support arms 56 having their lower ends removably anchored to the side of the trailer frame 36 and their upper ends rotatably supporting opposite ends of the roll bar 54. A pair of rafter arms 58 have inner ends anchored to the upper peripheral wall of the trailer and lower ends that operably engage an associate end of the roll bar when the awning is extended or can be releasably connected to a support arm at a location near the lower end of the support arm. As will be appreciated with the description that follows, the support arms 56 and the rafter arms 58 are telescopically extensible and can be releasably locked in an extended position to hold the awning in the extended position of FIGS. 1 and 3. The lower ends of the support arms can be disconnected from their attachment to the frame of the trailer 32 and pivoted outwardly as shown in FIG. 3 so as to rest on a supporting surface to provide an optional expanded position for the awning. As seen in FIGS. 1 and 3, the awning has a pull strap 60 operably secured to the roll bar. The pull strap wraps around the roll bar with the awning sheet when the awning is being retracted to the fully retracted position shown in FIG. 2. The pull strap is slightly longer than the awning sheet so that it is exposed and accessible as seen in FIGS. 9 and 10 even when the awning is fully retracted. When an operator pulls on the pull strap, it causes the roll bar to unroll against its spring bias and in doing so unwrap the awning sheet so that it becomes extended in a substantially flat orientation as seen in FIGS. 1 and 3.

As best seen in FIGS. 1, 3, 9, and 10, while the bias of the roll bar 54 urges the awning 34 toward the retracted position, it is best to secure the awning in the retracted position during towing of the trailer 32. To secure the awning in the retracted position, a securement strap 62 having a D-ring 64 at one end, a first Velcro fastener 66 at the other end and a second Velcro fastener 68 at an intermediate location along its length, is secured to the mounting rail 52 at an intermediate location along the length of the roll bar. As best seen in FIGS. 9 and 10, the mounting rail has an elongated groove 70 of C-shaped cross section and the securement strap is inserted laterally into the C-shaped groove. The securement strap is retained in the groove by the inner edge 50 of the awning sheet which has a hem therein and an anchor rod 72 inserted through the hem within the C-shaped groove, which holds the edge of the awning sheet in the C-shaped groove which in turn holds the securement strap within the groove. The D-ring hangs with a portion of the securement strap from the mounting rail while the remainder of the strap is extended outwardly above and around the retracted awning sheet 48. The free end of the securement strap with the first Velcro fastener 66 is passed through the D-ring, then folded rearwardly upon itself as seen in FIG. 9 so the first Velcro fastener can be releasably engaged with the second Velcro fastener 68 at the intermediate location along the length of the securement strap. Of course, to release the awning for deployment, the securement strap is merely released allowing the awning to be extended by pulling the pull strap 60 which causes the roll bar to unwind against its spring bias and allowing the awning sheet to be extended.

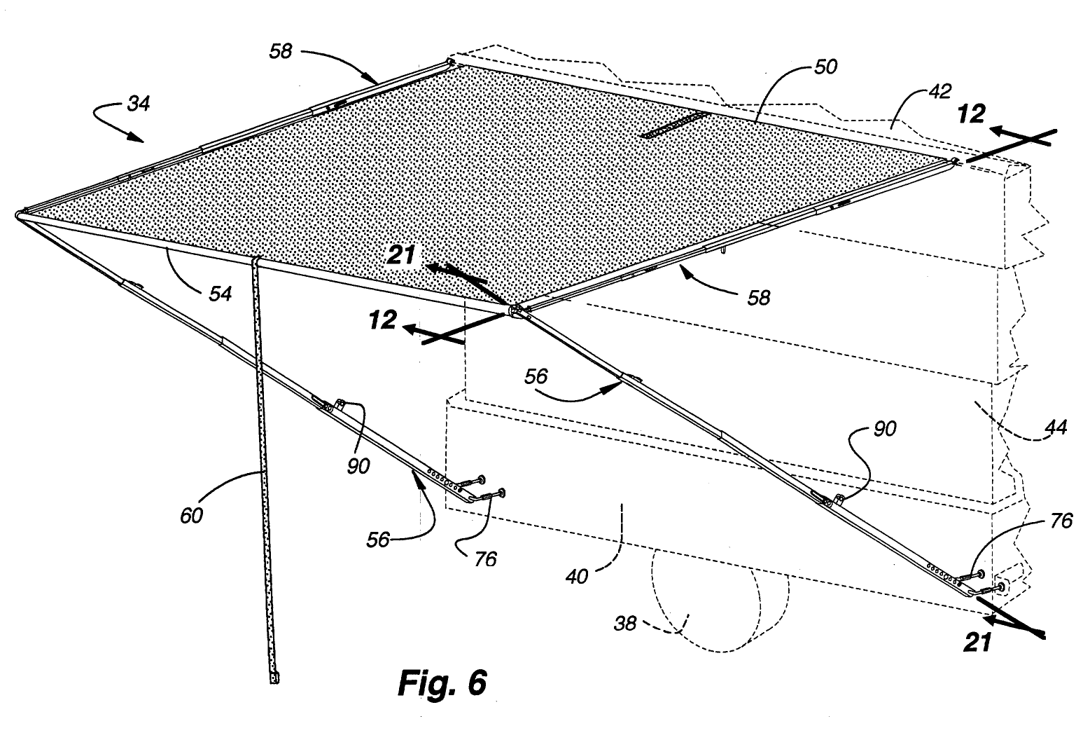

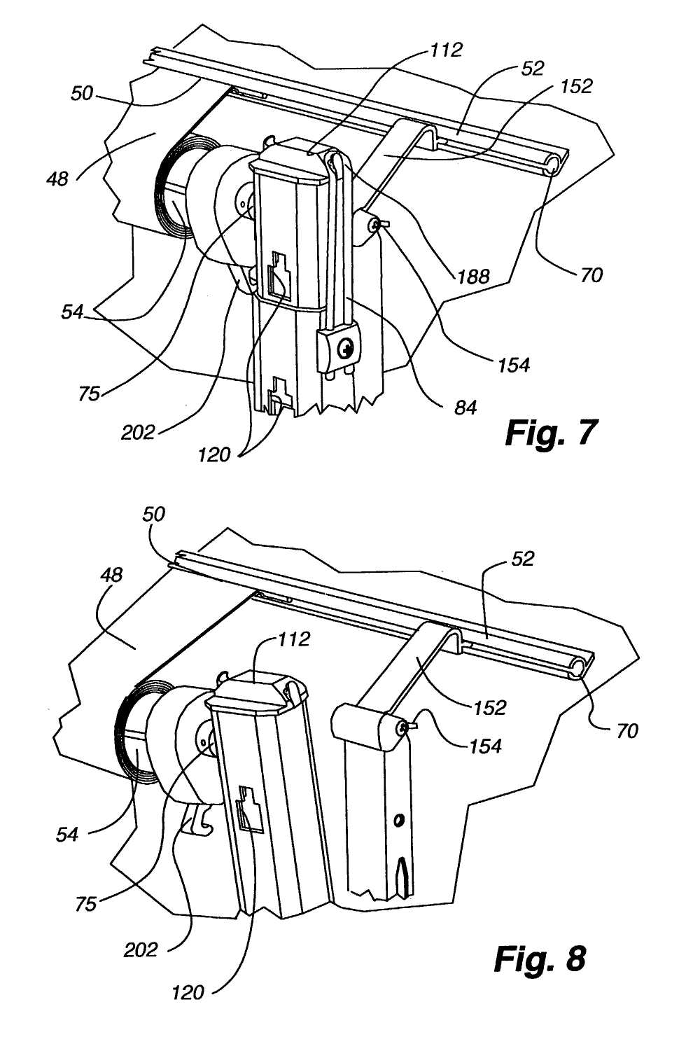

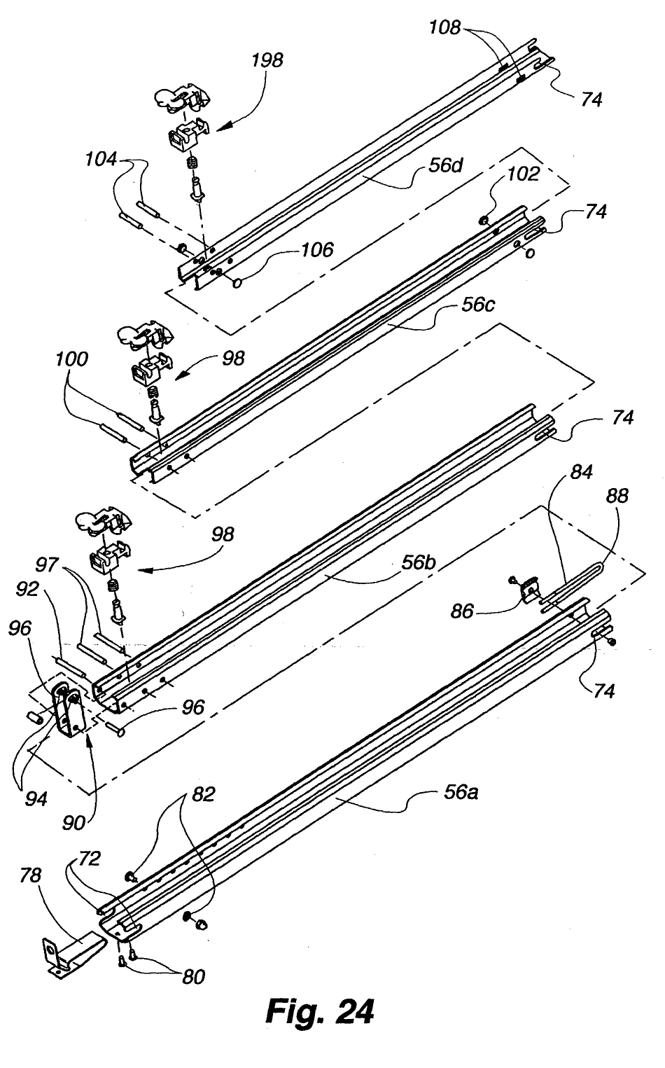

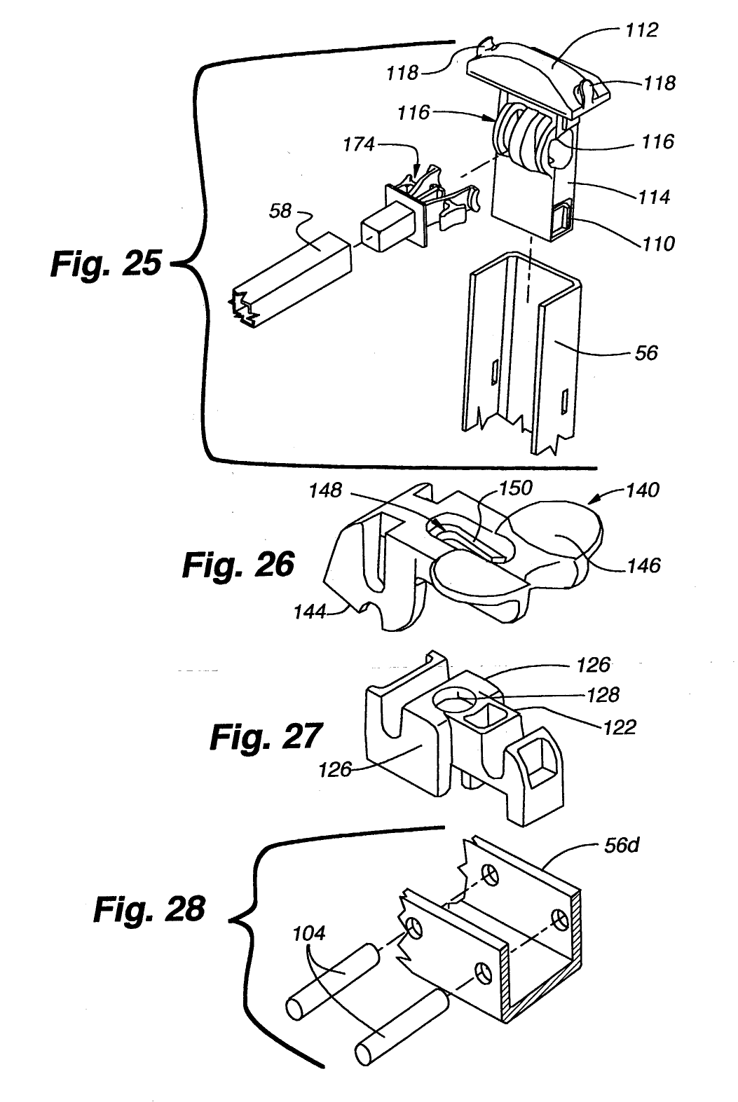

As mentioned previously, the support arms 56 are telescopic and are probably best seen in FIGS. 7, 8, 20-22, 24, and 25. Each support arm is identical, and, as best seen in FIG. 24, includes four elongated slidably related telescoping component parts 56a, 56b, 56c and 56d. Each component part is of generally U-shaped channel configuration with the inner or lowermost component 56a having the largest dimension and each outwardly successive component being slightly smaller so as to be slidably received within the next lower component. Each component has a notch 74 in its uppermost end for accommodating the support shaft 75 (FIGS. 7 and 8) of the roll bar 54 when the awning is fully retracted. The lower end of the component 56a part has notches 72 in opposite side walls which are adapted to be received on an associated U-shaped bracket 76 mounted on the frame 36 for the trailer 32. The brackets 76 are possibly best seen in FIG. 6. A spring clamp 78, the operation of which will be described in more detail hereafter, is secured to the lowermost end of the lowermost component 56a with a pair of fasteners 80 with the clamp being adapted to releasably connect the support arm 56 to an associated bracket 76 on the frame of the trailer. A button-type stop 82 is secured adjacent to the lowermost end of the lowermost component 56a in one of the side walls of the lowermost component with the button stop protruding a small distance into the open channel of the component so as to limit sliding movement of the next to the lowest component 56b relative to the lowermost component of the support arm as will be described later.

The opposite or uppermost end of the lowermost component 56a has an elongated elastic band 84 secured thereto with a clamp 86. The elastic band has a closed, loop-free end 88 for a purpose to be described later. At the lowermost end of the next to the lowest component 56b, a U-shaped bracket 90 is secured to the component with a fastener 92. The U-shaped bracket 90 has a pair of aligned openings 94 in the distal ends of a pair of legs 96 that project laterally away from the component 56b. The bracket is designed to releasably receive and secure the lower or outermost end of an associated rafter arm 58 as will be described later. Secured by fastener pins 97 to the component 56b adjacent to the bracket 90 is a spring-lock pin mechanism 98 which is manually operable to selectively permit or prohibit sliding movement of the next to the lowermost component 56b relative to the lowermost component 56a as will be described hereafter.

The next to the uppermost component 56c also has a spring-lock pin mechanism 98 secured adjacent to its lowermost end by a pair of fasteners 100 and it is adapted to selectively permit or prohibit sliding movement of the next to the uppermost component 56c relative to the next to the lowermost component 56b. The opposite or uppermost end of the next to the uppermost component has a button stop 102 mounted thereon so as to protrude into the open channel of the component.

The uppermost component 56d also has a spring-lock pin mechanism 98 mounted adjacent to its lowermost end by a pair of fasteners 104 and also a button stop 106 which protrudes inwardly into its open channel. The button stop 106 on the uppermost component 56d is positioned below the button stop 102 of the next to the uppermost component 56c so that when the components are being slidably separated, the button stops engage at full relative extension of the two components to prevent them from completely separating. Near the uppermost end of the uppermost component 56d, a pair of rectangularly-shaped openings 108 are provided in the side walls adjacent to the notches 74. The openings are adapted to receive spring-like button snaps 110 provided in the lower end of an end cap 112 shown best in FIGS. 7, 8, and 25.

The end cap 112 has a rectangular main body 114 adapted to be inserted into the open uppermost end of the uppermost component 56d of an associated side arm and is releasably secured therein by the button snaps 110 which retractably protrude into the rectangular openings. Located intermediately along the length of the main body 114 of the end cap are a pair of laterally directed holes 116 which are accessible through the notches 74 found in the uppermost ends of the support arm components. When the components 56a-56d are fully nested, as when the awning is fully retracted, the uppermost component 56d protrudes away from the upper end of the lowermost component 56a a slight distance as seen in FIG. 7 so the elastic band 84 can be stretched upwardly and looped over one of two anchor fingers 118 provided on the top of the end cap 112. In this manner, the component parts of the support arm 56 are held tightly in nested relationship and with the awning fully retracted. This is the position of the support arms when the trailer is collapsed as shown in FIG. 2.

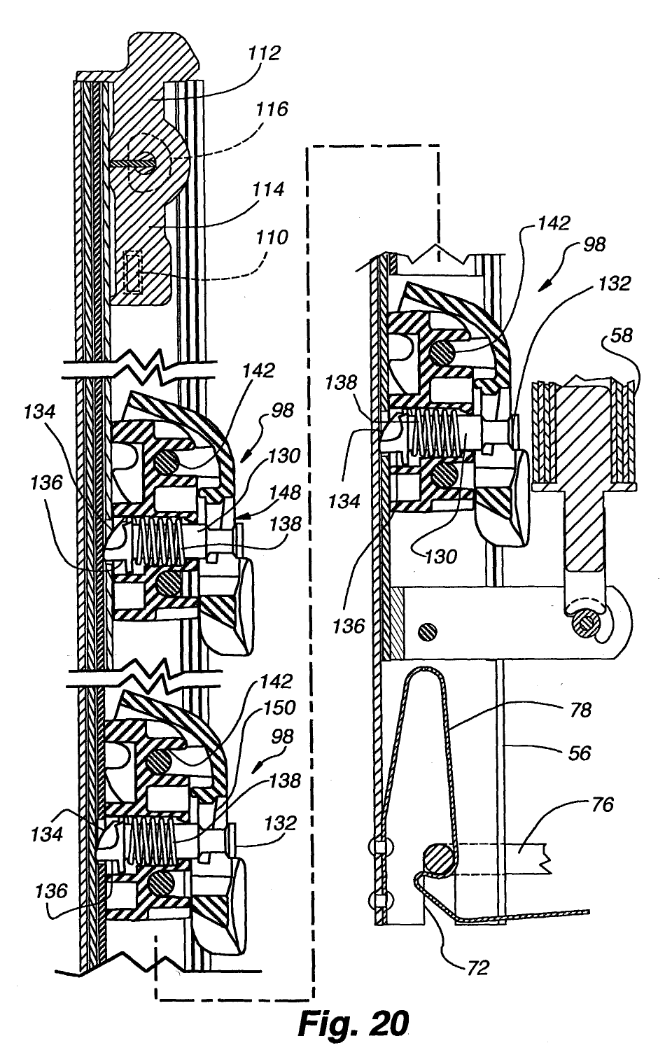

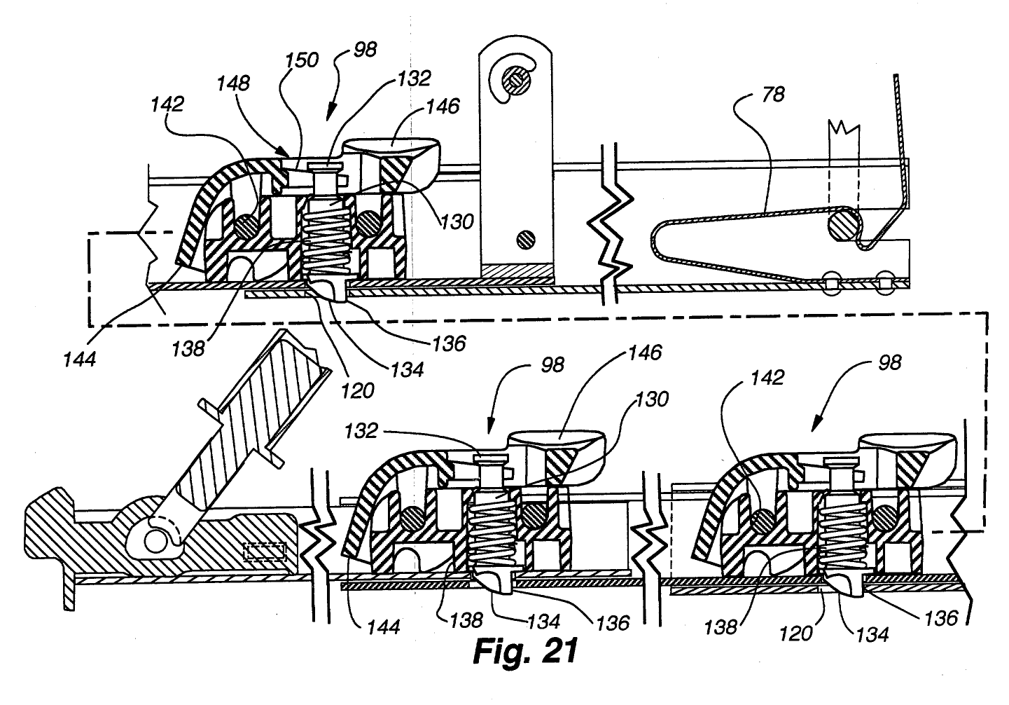

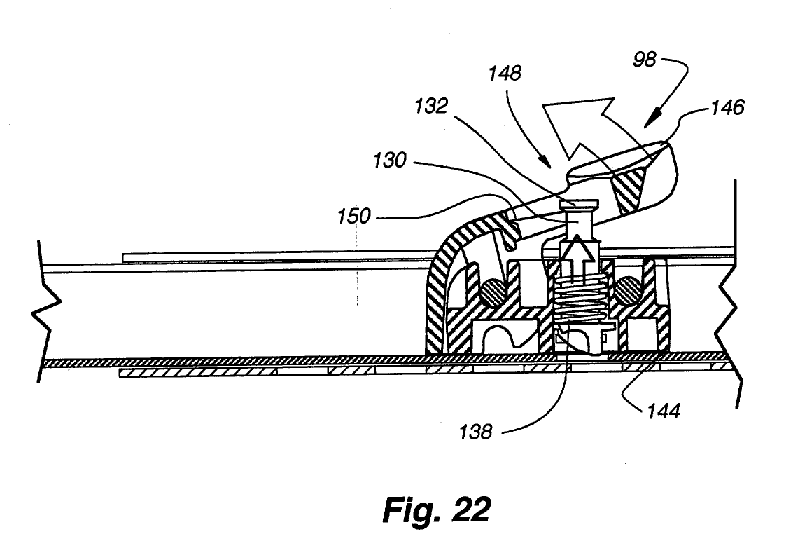

The lower three sections 56a, 56b and 56c of each support arm have an opening 120 adjacent the upper end thereof that extends through the base of the component with some of the openings seen best in FIGS. 7, 8 and 21. The openings cooperate with the spring-lock pin mechanisms 98 which are also seen in the same figures and in more detail in FIGS. 26 and 27. It will be seen best in FIGS. 26 and 27 that each spring-lock pin mechanism 98 has a base 122 that is seated in its associated component and held in place by the associated pair of traverse fastener pins 97, 100 or 104 that pass through the lateral side walls of the associated channel component. Each base 122 has a pair of legs 126 that define therebetween a circular passage 128 that slidably receives a lock pin 130 (FIGS. 20-22) having an enlarged cap 132 at its upper end and a beveled lower end or head 134 that also defines a flat abutment surface 136. A compression spring 138 sits within the passage 128 and biases the pin 130 downwardly toward the bottom wall of the channel component in which it is mounted. Each spring-lock pin mechanism also includes a pivot arm 140 having a transverse circular passage 142 that receives one of the pins 97, 100 or 104 used to anchor the base 122 so that the pin serves as a pivot shaft for the pivot arm 140. The pivot arm has a bottom surface 144 on one end adapted to engage the bottom wall of the channel component in which the spring-lock pin mechanism is mounted when the pivot arm is fully pivoted in a counterclockwise direction as viewed in FIGS. 20-22. The pivot arm also has a finger-engaging plate 146 at its opposite end which projects above the channel component. Adjacent to the finger plate is an opening 148 through the pivot arm that receives the upper end of the lock pin 130 and a lift ledge 150 projects into the opening 148. The lift edge is adapted to engage the enlarged cap 132 of the lock pin when the finger plate is lifted as seen in FIG. 22. When the finger plate is not lifted, the lock pin is biased downwardly by the compression spring 138 thereby yieldingly holding the pivot arm in a neutral position with the beveled head 134 of the lock pin being forced through the opening 120 in the base of the component 56a, 56b or 56c in which the spring-lock pin is mounted. If the lock pin is aligned with the opening 120 in the next adjacent support arm component, it will also project through that opening as seen in FIG. 21. If the opening in the next adjacent component is not aligned with the lock pin, the lock pin is biased against the internal surface of the next adjacent component and slides along that component until aligned with the opening 120 at which point the lock pin is forced into the opening by the compression spring 138. Once in the opening, the adjacent support arm components are releasably secured in the extended position and will not retract due to the flat abutment surface 136 on the head of the lock pin unless the finger plate 146 is lifted to remove the lock pin from the opening in the next adjacent channel component.

The support arm components 56a-56d can be automatically extended, however, and the beveled head 134 of each lock pin mechanism 98 serves as a cam in forcing the associated pin 130 upwardly against the spring bias so the pin allows the adjacent components to extend relative to each other. However, when the components are fully extended relative to each other, the pins 130 snap into the openings in the adjacent channel components and due to the flat abutment surface 136 of the pin head, prevent the components from being retracted or collapsed into nested relationship until the spring-lock mechanisms are manually released. It will be appreciated from the above that the four components of each support arm are slidably related but prevented from being slidably separated by the button stops 82, 102 and 106 and the spring-lock pin mechanisms 98. While the components can be readily separated from their fully nested relationship to a fully extended longitudinally aligned relationship merely by pulling on the upper end of the uppermost component, once the arms are fully extended and denested, they will automatically lock into position through the cooperation of each spring-lock pin mechanism with the next adjacent support arm component.

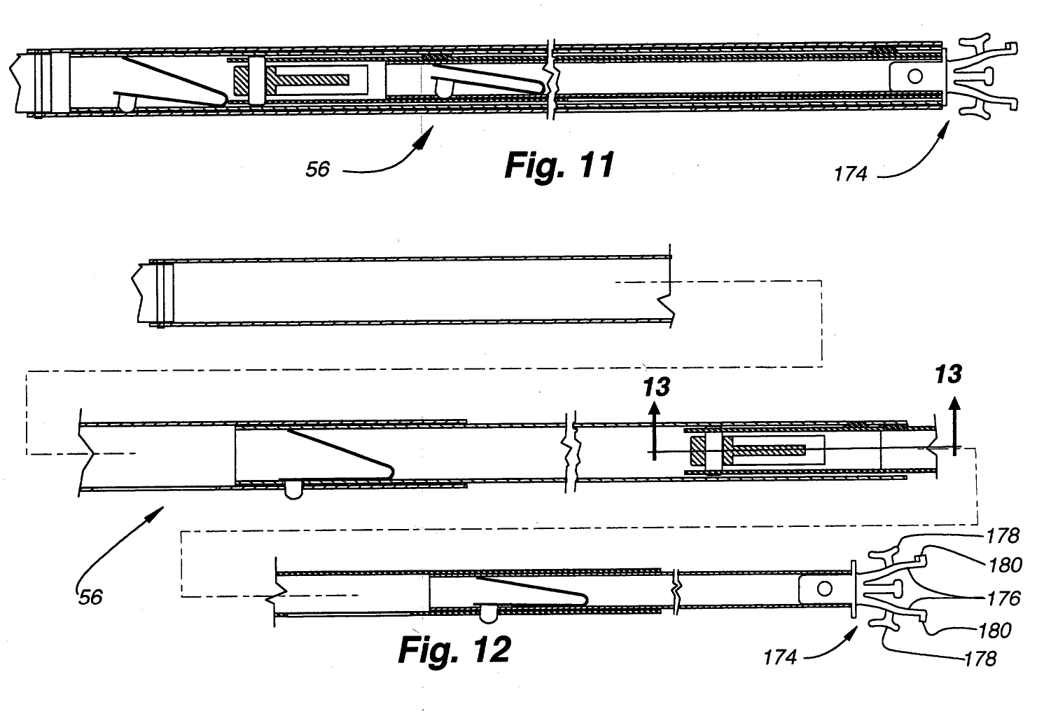

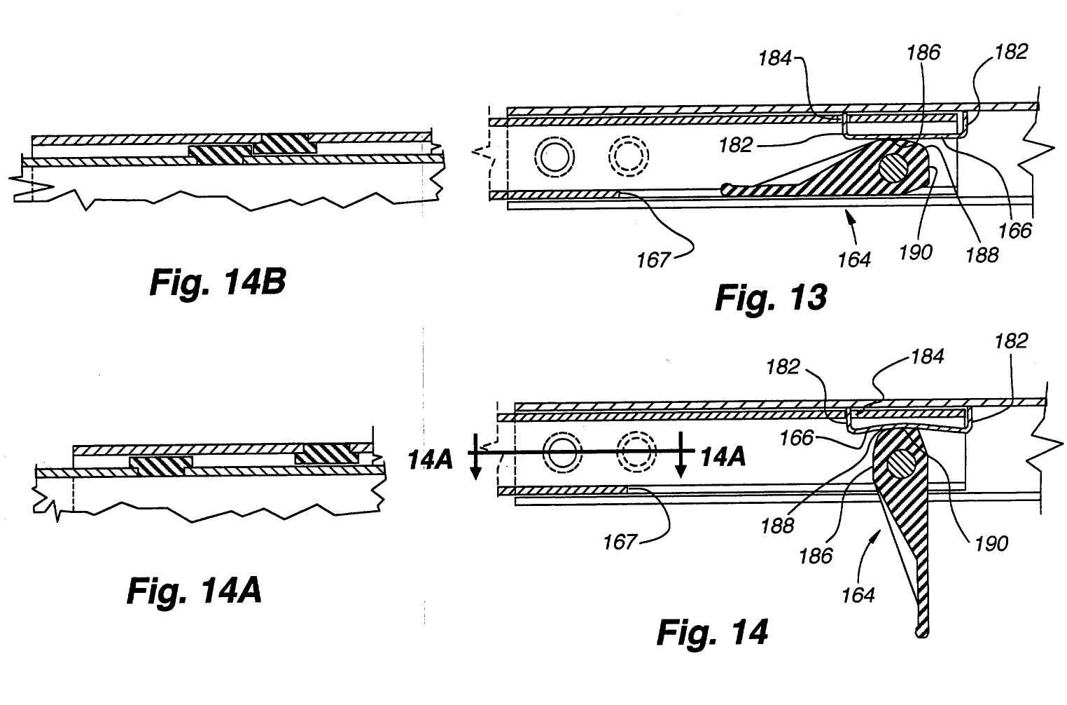

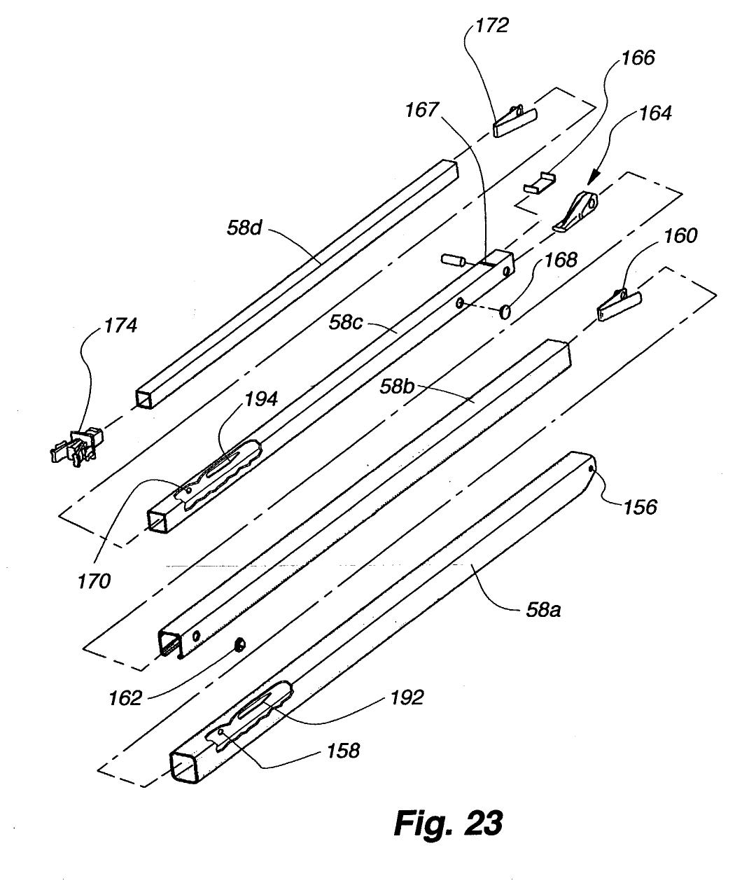

The rafter arms 58 are best seen in FIGS. 5, 11-19, and 23. In FIG. 23, each rafter arm can be seen to include four slidably related and telescoping components 58a-58d with the lowermost component 58a and the uppermost two components 58c and 58d being of square tubular configuration. The next to the lowest component 58b is of U-shaped channel configuration. The lowermost component as viewed in FIG. 23 might also be referred to as the innermost component as it is connected to the upper peripheral wall 42 of the trailer at its innermost end. The upper peripheral wall of the trailer has a pair of brackets 152 as seen best in FIG. 8 which are mounted on the side rail 52 and extend laterally and downwardly away from the rail. The brackets have a transverse support pin 154 adapted to be received in a pair of laterally-aligned openings 156 (FIG. 23) in the innermost end of the innermost component 58a of an associated rafter arm. The opposite end of the innermost component has a hole 158 in one of its side walls which is adapted to cooperate with a button-spring lock 160 positioned internally of the innermost end of the next to the innermost component 58b. The opposite or outer end of the next to the innermost component has a button stop 162 mounted interiorly thereof for a purpose to be described later. The next to the outermost component 58c has a pivot clamp or auxiliary lock 164, to be described in more detail later, mounted interiorly thereof and is adapted to cooperate with an abutment plate 166 to releasably secure or prevent the next to the outermost component 58c from sliding relative to the next to the innermost component 58b. The lower surface of the next to the outermost component is notched at 167 (FIGS. 13 and 14) to permit finger access to the pivot clamp or lock 164 for operation thereof through the notch and through the open side of the next to the innermost component as will be described later. Another button stop 168 is mounted adjacent to the pivot lock to prevent the next to the outermost component 58c from being slidably released from the next to the innermost component 58b. The button stop 168 in the next to the outermost component is positioned inwardly toward the trailer from the button stop 162 in the next to the innermost component. The opposite or outer end of the next to the outermost component has a hole 170 in a side wall thereof and it is adapted to cooperate with a button-spring lock 172 positioned internally of the innermost end of the outermost component 58d. The outermost end of the outermost component has a compressible spring latch 174 inserted and received in the open end thereof with the spring latch being adapted to be releasably connected to the bracket 90 on an associated support arm 56 or to the end cap 112 of the support arm depending upon whether or not the awning is fully retracted or extended, respectively.

The rafter arms 58 will automatically extend from their fully retracted positions of FIG. 2 until the button spring locks engage openings in the next adjacent components so as to project into the opening and prevent relative slidable movement between the adjacent components. The rafter components cannot be retracted into a nested relationship, however, until the button spring locks are manually depressed to release the adjacent components for slidable movement and the pivot lock is released as will be described later.

The compressible spring latch 174, as is possibly best seen in FIGS. 12 and 15, has a pair of legs 176 and is made of a somewhat flexible but resilient material, such as plastic, having memory so the legs can be manually compressed toward each other through a pair of finger-engaging pads 178 on opposite legs but upon release will return to the position shown in FIGS. 12 and 15. When the awning is retracted, the legs 176 are compressed toward each other so they can be inserted between the legs 96 of the bracket 90 on an associated support arm and when released lips 180 on the ends of the legs extend into the openings 94 in the legs 96 to releasably secure the lower end of the rafter arm to an associated support arm. When the awning is to be extended, however, the legs 176 are again manually compressed toward each other so as to be released from the bracket 90 and after the support arms 56 have been pivoted away from the side of the trailer, the outer end of the rafter arm, having the compressible latch 174 thereon, is swung upwardly and inserted into the end cap 112 at the outer end of the support arm where the legs can be released causing the lips 180 to be inserted into the holes 116 in the lateral side walls of the body of the end cap to releasably secure the outer end of the rafter arm to the upper end of the support arm thereby retaining the awning in the extended position of FIGS. 1 and 3.

The rafter arms 58 can be used to stretch the awning sheet, i.e. hold it taut, by pushing the roll bar 54 outwardly with one hand and pivoting the pivot lock 164 with the opposite hand which releasably secures an extended relationship between the next to the outermost component 58c and the next to the innermost component 58b of a rafter arm as best illustrated in FIGS. 13 and 15. In FIGS. 13 and 14, it will be seen that the abutment plate 166 has a pair of parallel legs 182 with one of the legs projecting through a slot 184 in the next to the outermost component 58c and the other leg extending beyond the innermost end of the next to the outermost component. The abutment plate is in engagement with a lateral side 186 of the pivot lock and adjacent to a cam surface 188 on the pivot lock such that when the pivot lock is disengaged as shown in FIG. 13, the legs 182 of the abutment block merely slide along the inner surface of the next to the innermost component 58b but when the pivot lock is pivoted into a locking position shown in FIG. 14, the cam surface 188 commences to compress the abutment plate 166 so the legs tightly engage the inner surface of the next to the innermost component thereby releasably securing the components together to prevent relative sliding movement. A flattened surface 190 on the end of the pivot lock encourages the pivot lock to remain in a locked position until forced manually in a counterclockwise direction to the neutral position of FIG. 13.

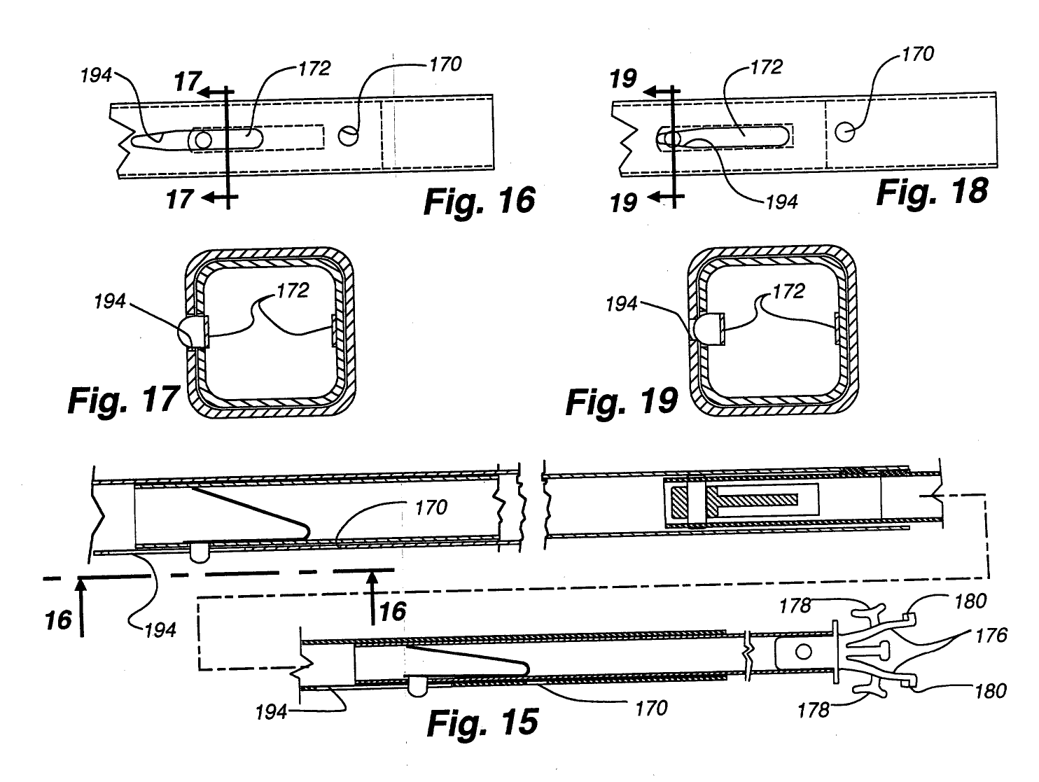

As best seen in FIGS. 16-19, in addition to the apertures 158 and 170 in the outermost ends of both the innermost component 58a and the next to the outermost component 58c for receiving the button-spring locks 160 and 172, respectively, teardrop-shaped slots 192 and 194, respectively, are also provided. The button-spring lock 160 of the next to the innermost component, for example, is manually positioned in the teardrop slot 192 of the innermost component and similarly the button-spring lock 172 in the outermost component is manually positioned in the teardrop slot 194 of the next to the outermost component when the awning is collapsed. In the fully collapsed position, the buttons on the spring locks are seated within the large end of the teardrop slots but as the rafter components are extended as when the awning is extended, the tip of the button of each button spring lock which is rounded serves as a cam surface and is thereby compressed or forced inwardly as the button moves toward the smaller end of the teardrop slot so as to retract the button and allow the components to slide relative to each other.

It will be appreciated from the above that when the awning is fully retracted as shown in FIG. 2, the rafter arm components 58a-58d and the support arm components 56a-56d are fully nested. However, when the trailer is extended or raised to the position of FIGS. 1 and 3, the support arms and rafter arms automatically extend until the support arms are fully extended and automatically lock relative to each other to prevent further extension or retraction. At that point in time, the securement strap 62 can be released from its circumscribing relationship with the awning sheet 48 on the roll bar 54 and the awning sheet extended to the position of FIGS. 1 and 3 by pulling on the pull strap 60 which pulls the roll bar away from the side of the trailer as the awning sheet unrolls from the roll bar. As this is occurring, the rafter arms 58 remain attached at their upper ends to the mounting rail 52 on the upper peripheral wall 42 of the trailer and on their lower ends to the bracket 90 near the lower end of an associated support arm 56. The lower end of the rafter arm can then be released from the bracket 90 and swung upwardly to be connected to the end cap 112 of the associated support arm. It is to be noted, however, that until the pivot lock 164 between the second to the innermost and the second to the outermost rafter components 58b and 58c, respectively, is secured, those two components will slide relative to each other. Accordingly, before the awning can be secured in the extended position of FIGS. 1 and 3, the roll bar 54 is pushed outwardly with one hand while the other hand pivots the pivot lock into the locked position of FIG. 14 which secures the rafter arms in a fully extended position and with the awning sheet stretched tight. At this point in time, the awning is fully extended as illustrated in FIG. 1, but should the operator desire to have the awning assume the position of FIG. 3, the lower end of the support legs 56 can be released from the supporting brackets 76 and swung outwardly to the position of FIG. 3 so they extend vertically from the ground or other supporting surface. If the supporting surface is dirt or other relatively soft material, a stake 196 can be driven through an opening 198 provided in the spring clamp 78 as shown in FIG. 4 to secure the support arm in the vertical position.

To release the lower end of the support arms from the support brackets 76, as best seen in FIG. 20, the spring clamp 78, which can be seen to have an arcuate seat 200 formed therein, is pulled outwardly until the seat is removed from the bracket at which time the associated support arm can be swung away from the bracket. Of course, a reverse process allows the support arm to be resecured to the bracket.

To retract the awning from the extended position of FIG. 1, the button spring locks 160 and 170 as well as the pivot locks 164 are released in the rafter components so the rafters can be moved toward a retracted or nested position after the compressible spring latch 174 at the outer end of the rafter arm is compressed and removed from the end cap 112 on the upper end of the support arm. The outer end of the rafter arm is then swung downwardly so the compressible spring latch can be secured to the bracket 90 on the associated support arm. It is important to appreciate that in this condition, the rafter arms can be further compressed or retracted until fully nested which occurs naturally when the trailer 32 is collapsed as will be described hereafter. After reconnecting the rafter arms to the bracket 90 on the support arms, the spring-lock mechanisms 98 on the support arms are all released so the awning is allowed to retract naturally under the spring bias conventionally provided within the roll bar 54. Once the awning sheet is fully wound about the roll bar and is positioned adjacent to the upper peripheral wall 42 of the trailer, the securement strap 62 is extended around the awning sheet and secured to itself to secure the roll bar adjacent to the upper peripheral wall of the trailer. It is again important to note that in this position, not only are the rafter arms conditioned for further collapsing movement toward a nested position but so are the support arms. Accordingly, when the trailer 32 is collapsed by dropping the upper peripheral wall toward the lower peripheral wall, the support arms and rafter arms fully collapse to the position shown in FIG. 2.

While it will not be described in detail herein, the roll bar 54 is a conventional item and could be of the type described in U.S. Pat. No. 4,530,389, which is commonly owned with the present application and includes a lock lever 202 (FIGS. 7 and 8) which is movable between one position in which it prevents the roll bar from rolling in a clockwise direction and another position in which it prevents the roll bar from rotating in a counterclockwise direction. Of course, one position is used when the awning is fully retracted as a backup to the securement strap 62 to prevent deployment of the retractable awning and the other lock position is used when the awning is fully extended to assist the support and rafter arms in retaining the awning in the fully extended position.

Although the present invention has been described with a certain degree of particularity, it is understood the present disclosure has been made by way of example, and changes in detail or structure may be made without departing from the spirit of the invention as defined in the appended claims.

1. A pop-up trailer and retractable awning comprising in combination:
a trailer having a lower peripheral wall, an upper peripheral wall, and an expansible side wall therebetween, said upper peripheral wall being vertically movable relative to said lower peripheral wall between an expanded position wherein said upper peripheral wall is vertically spaced from said lower peripheral wall and a collapsed position wherein said upper peripheral wall is adjacent to said lower peripheral wall, and
a retractable awning mounted on said trailer for movement between an extended position and a retracted position, said retractable awning including an awning sheet having an inner edge operatively secured to said upper peripheral wall and an outer edge adapted to be extended away from said upper peripheral wall, a roll bar positioned along one of said inner or outer edges, and about which said awning sheet can be wrapped when the awning is retracted, a pair of support arms having inner ends operatively connected to said lower peripheral wall and outer ends operatively connected to the outer edge of said awning sheet, and a pair of rafter arms having inner ends operatively connected to said upper peripheral wall and outer ends operatively connectible to said outer edge of said awning sheet, said support arms being longitudinally extensible and automatically extend when said trailer is moved from its collapsed position to its expanded position.

2. The combination of claim 1 wherein said rafter arms are longitudinally extensible and automatically extend when the outer end is moved away from the inner end.

3. The combination of claim 1 wherein said support arms are telescopic and include a plurality of longitudinally slidable components and releasable lock members for securing the arms in an extended position.

4. The combination of claim 2 wherein the rafter arms are telescopic and include a plurality of longitudinally slidable components and releasable lock members for securing the arms in an extended position.

5. The combination of claim 4 wherein the rafter arms further include ancillary lock members allowing a predetermined amount of sliding movement between at least two of said slidable sections of the rafter arms.

6. The combination of claim 1 wherein the inner ends of said support arms are releasably operably connected to said lower peripheral wall.

7. The combination of claim 1 wherein said roll bar is secured to said outer edge of said awning sheet.

8. The combination of claim 1 wherein said outer ends of said rafter arms are releasably and operably connectible to said outer edge of said awning sheet and releasably connectible to an intermediate location along the length of a support arm.

9. The combination of claim 8 wherein said outer ends of said rafter arms are operably connected to said support arms when the awning is retracted and operatively connected to said outer edge of the awning sheet when the awning is extended.

10. The combination of claim 7 wherein said roll bar is rollably biased in one direction of rotation about a longitudinal axis thereof and said bias urges the awning toward said retracted position.

11. The combination of claim 3 further including a releasable lock system for securing said slidable components in a retracted position.

12. The combination of claim 3 wherein said lock members are spring-lock pins.

13. The combination of claim 11 wherein said lock system includes a resilient strap secured to one section of a support arm and a catch on another section of the support arm to which said resilient strap can be releasably connected.
